(19) United States
(12) Patent Application Publication
(10) Pub. No.: US 2026/0228747 A1
(43) Pub. Date: Aug. 6, 2026

(54) SYSTEMS AND METHODS FOR MANAGING ISSUES IMPACTING OPERATION OF DATA PROCESSING SYSTEMS

(71) Applicant: Dell Products L.P., Round Rock, TX (US)

(72) Inventors: GOKUL THIRUCHENGODE VAJRAVEL, Bangalore (IN); VIVEKANANDH NARAYANASAMY RAJAGOPALAN, Bangalore (IN)

(21) Appl. No.: 19/043,698

(22) Filed: Feb. 3, 2025

(51) Int. Cl. G06Q 30/01; G06F 11/07

(52) U.S. Cl. CPC G06Q 30/01; G06F 11/0784; G06F 11/0793

(57) ABSTRACT

Methods and systems for managing operation of a data processing system are disclosed. To manage operation of the data processing system, an issue impacting desired computer implemented services from being provided by the data processing system may be obtained. Based, at least in part, on the issue, at least one person to be notified of the issue may be identified and a classification for the issue may be obtained based on a trained classification model. A channel for the at least one person may be identified based on the classification and using the channel associations (e.g., association between the channel and classification for the issue). By doing so, information regarding the issue may be communicated to the at least one person to initiate remediation of the issue to facilitate continued provisioning of desired computer implemented services.

### FIELD

Embodiments disclosed herein relate generally to providing customized services to users of data processing systems. More particularly, embodiments disclosed herein relate to systems and methods to managing operation of at least one data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a diagram illustrating data flow in accordance with an embodiment.

FIG. 3 shows a flow diagram illustrating a method for managing operation of at least one data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services to users of data processing systems. To provide the computer-implemented services, the system may include any number of data processing systems (e.g., computing devices, data centers, etc.) with in-band components (e.g., various hardware components and/or software resources). The in-band components may perform various processes including startup processes, software installation processes, and/or other types of processes. When performing these processes, the in-band components may experience an issue (e.g., failure, error, etc.) impacting function of the data processing system and therefore, decreasing the likelihood of the desired computer implemented services of being provided by the data processing system.

In order to manage continued provisioning of the desired computer implemented services, the data processing system may provide information regarding the issue via select interfaces (e.g., graphical user interfaces) of a management system (e.g., another data processing system, computing device, etc.). For example, the information regarding the issue (e.g., notification indicating error with the in-band components) may be provide through a graphical user interface of the management system operated by an administrator (e.g., technological personnel with authorized management of the data processing system). Thus, requiring a person to be local to the management system providing management services to the data processing system. Consequently, the person tasked with managing the remediation of issues impacting the data processing system may be unable to identify the issues to ensure continued performance of computer implemented services.

In order to manage remediation of issues impacting data processing systems, a customized notification process to communicate information regarding the issue to a person (e.g., tasked with remediating the issues) may be implemented by a management system. The customized notification process may be established, for example, by an administrator of the data processing systems and may identify a channel (e.g., independent communication path) between the management system and the person usable to communicate the information regarding the issue based on different classifications for different types of issues. The classification for the issue may be obtained based on a trained classification model (e.g., a trained machine learning model and/or inference model trained to generate inferences based on responses for remediating historic issues impacting the data processing systems) and used to identify each channel associated with persons to be notified based on the issue. By

The management system may communicate information regarding the issue to each person tasked with remediating the issue and/or managing operation of the data processing systems in a customized manner based on channels associated with each person and classification of the issue. By doing so, the likelihood of initiating remediation of the issue (e.g., by the person(s)) may be increased, and thereby, increasing the likelihood of facilitating continued provisioning of desired computer implemented services by the data processing system.

In an embodiment, a method for providing customized services to users of data processing systems is disclosed. The method may include: identifying an issue impacting operation of the at least one data processing system; identifying at least one person to be notified of the issue based on the issue; obtaining a classification for the issue based on a trained classification model; identifying, for each of the at least one person and using channel associations, a channel based on the classification; and communicating information regarding the issue to each of the at least one person based on the channel to initiate remediation of the issue to facilitate continued provisioning of desired computer implemented services by the at least one data processing system.

The channel associations may specify, for a person of the at least one person, associations between a plurality of different channels and a plurality of different classifications for issues.

Each of the plurality of different channels may include independent communication paths between a management system and the person.

The independent communication paths may be each in different fault zones.

The trained classification model may classify a severity level of the issue.

The trained classification model may classify a priority level for the issue.

The trained classification model may be a trained machine learning model based on training data obtained from a plurality of data processing systems and corresponding responses for remediating historic issues impacting the plurality of data processing systems.

The at least one data processing system may be a member of a deployment tasked with providing the desired computer implemented services to users, and the issue may reduce a likelihood of the deployment being able to provide the desired computer implemented services.

Identifying the issue may include: obtaining a communication from monitoring software hosted by the at least one data processing system, the communication indicating that the at least one data processing system is impacted by the issue.

The method may also include: after communicating the issue: monitoring the operation of the at least one data processing system until the issue is resolved by action of the at least one person induced by the communicating of the issue; and making the issue as resolved.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

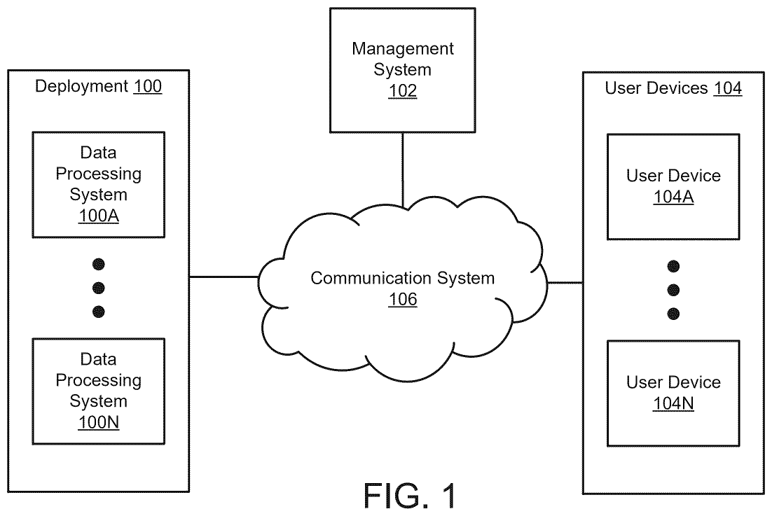

Turning to FIG. 1, a block diagram illustrating a system in accordance with an embodiment is shown. The system shown in FIG. 1 may provide, at least in part, computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided by, for example, deployment 100, management system 102, user devices 104, and/or any other type of devices (not shown in FIG. 1). Other types of computer-implemented services may be provided by the system shown in FIG. 1 without departing from embodiments disclosed herein.

To provide the computer-implemented services, deployment 100 may include any number of data processing systems (e.g., data processing system 100A—data processing system 100N). Each of the data processing systems may include hardware components (e.g., processors, memory modules, storage devices, etc.) and/or software components (e.g., operating system, device drivers, application programs, etc.) which may be used, at least in part, to provide the computer-implemented services. For example, deployment 100 may be a data center including various components such as, servers, routers, storage systems, security systems, etc. that host operating systems, applications, etc. that perform different processes in order to provide computer-implemented services.

Over time, operation of the hardware resources and/or software components hosted by the hardware resources (e.g., applications) may be limited and/or fail (e.g., due to insufficient resources, software defects, etc.). Failure of and/or limited operation of the hardware and/or software components may negatively impact continued provisioning of the computer-implemented services by the data processing system. To manage failures and/or reduced functionality of the hardware resources and/or software components hosted by the hardware resources, a monitoring agent may be hosted by the data processing system (e.g., more specifically by the hardware resources of data processing system 100A). The monitoring agent may include a software program responsible for monitoring operation status of the hardware resources and/or software components while providing the computer-implemented services. By monitoring the operation of the hardware resources and/or software components, errors and/or undesired activity impacting operation of the data processing system may be identified, monitored, and/or otherwise managed.

However, the data processing system may lack the capabilities (e.g., due to insufficient resources) to manage the errors and/or issues impacting operation of the data processing system. For example, the data processing system may not have enough computing resources (e.g., processing resources, memory resources, and/or any other computer resources) to consistently monitor, identify, and implement necessary modifications to the software components hosted by the hardware resources (e.g., applications) in order to provide the computer-implemented services desired by the user. Notifications including information regarding errors and/or issues impacting operation of the data processing system may be provided to a management entity (e.g., management console and/or any other management system) operated by a person (e.g., system administrator, information technology decision maker (ITDM), and/or any other person tasked with managing operation of the data processing system).

For example, the person may receive a notification via a graphical user interface (e.g., display, monitor, etc.) hosted by endpoint device 104A. However, the notification (and/or content indicating the occurrence of the issue) may not be displayed by the user device due to differences in user device architecture and/or notification capabilities. For example, the method of displaying content indicating the occurrence of the issue invoked may be based on the communication channel associated with the type of issue impacting the device, the type of device and/or notification capabilities of the device.

Even if the format of the notification is usable by the user device, the person may not receive the notification. For example, the graphical user interface may only display a limited amount of information, if any, regarding the error or issue impacting operation of the data processing system. Thus, when such notifications including the information regarding the issue are obtained, a person may need to be local to the data processing system to view the graphical user interface to understand and/or perform an action to initiate remediation of the issue impacting the operation of the data processing system.

In general, embodiments disclosed herein may provide systems and methods usable to managing operation of at least one data processing system by communicating an issue impacting operation the at least one data processing to at least one person using an identified channel. The channel for the at least one person may be identified based on a classification of the issue and may identify an independent communication path between a management system and the at least one person. By communicating the issue using the identified channel, the at least one person may initiate remediation of the issue impacting the at least one data processing system. By doing so, the likelihood of remediating the issue may be increased while conserving limited resources and thereby facilitating continued provisioning of desired computer implemented services by the at least one data processing system as part of a deployment.

To provide the above noted functionality, the system of FIG. 1 may include deployment 100, management system 102, user devices 104, and communication system 106. Each of these components is discussed below.

Deployment 100 may provide computer-implemented services (e.g., to users of deployment 100 and/or to devices operably connected to deployment 100). To do so, deployment may include any number of data processing systems (e.g., 100A-100N) that may be used by businesses, individuals, and/or other users. Deployment 100 may include data processing systems including any number of hardware and/or software components configured to provide the computer-implemented services.

To perform their functionality, data processing system 100A may: (i) monitor operation of the hardware components and/or software resources (e.g., hosted by the data processing system), (ii) identify an issue impacting operation of data processing system 100A (e.g., any type of issue that requires administrative intervention), (iii) provide one or more communications regarding operation status of the data processing system (e.g., including information regarding the issue) to users (e.g., of the data processing system), management system 102, and/or user devices 104, (iv) receive communications (e.g., including instructions to manage operation of software resources of data processing system 100A) from management system 102, endpoint devices 104, and/or any other authorized management devices, and/or (v) perform other tasks.

When providing the computer-implemented services, for example, data processing system 100A may identify an issue negatively impacting an ability to facilitate provisioning of the computer implemented services.

To identify the issue, data processing system 100A may host a monitoring agent (e.g., a software program) and/or may communicate with external entities (e.g., management system 102 and/or other management devices). For example, the monitoring software may monitoring operation of data processing system 100A and identify issues impacting operation of data processing system 100A. For example, the monitoring software may identify an occurrence of a failure of a storage device of data processing system 100A to store data.

User devices 104 may include any type and/or number of user devices (e.g., 104A-104N). Each user device of user devices 104 may include hardware and/or software components configured to obtain data, store data, provide data to other entities, and/or to perform any other task to facilitate performance of the computer-implemented services. All, or a portion, of user devices 104 may provide (and/or participate in and/or support the) computer-implemented services to various devices operably connected to user devices 104. Different user devices may provide similar and/or different computer-implemented services.

User devices 104 may receive notifications from management system 102 (e.g., via a communication system) and may access to data and/or manage any of data processing systems 100A-100N. User devices 104 may be organized so that each user device of user devices 104 is associated with a user of user devices 104, and an user device assigned to a user may be allowed to store, modify, and/or access the data in a data processing system associated with the user. For example, user device 104A and user device 104B may be associated with a first user (e.g., administrator of deployment 100) and user device 104C may be associated with a second user (e.g., another administrator of deployment 100).

To obtain the information regarding issues impacting data processing system 100A by user devices 104, management system 102 may identify a user to be notified of the issue and the mechanism in which information regarding the issue may be communicated through to the identified user to initiate remediation of the issue.

Management system 102 may perform tasks relating to management of and/or facilitation of use of deployment 100 (e.g., any of data processing systems 100A-100N). Management system 102 may include any number and/or type of devices (e.g., other data processing systems, servers, storage devices, user devices) that may be used to manage the data processing systems. As part of managing the data processing systems, management system 102 may train and/or host any number and/or type of machine learning models and/or inference models trained to obtain classifications (e.g., inferences) for different types of issues. The trained machine learning model may include generative artificial intelligence (AI) inference models (e.g., large language models (LLMs)); therefore, the responses may include new instances of data created by the generative AI inference models based on learned associations established during inference model training. For example, the inference models may be trained using unstructured data, such as stories, essays, audio transcription, video description, and/or other types of human interpretable text, to generate responses of the same. The notifications of issues provided to management system 102 by data processing systems 100A-100N may be used as input data for the trained machine learning models managed by management system 102.

To perform its functionality, management system 102 may: (i) obtain notifications and/or any form of communication from data processing systems 100A-100N regarding issues impacting the respective data processing system, (ii) identify a type of issue impacting operation of the data processing system, (iii) identifying (at least one) person to be notified of the issue impacting the desired computer implemented services being provided by the data processing system (e.g., based on at least the notification and/or the type of issue indicated by the notification), (iv) obtaining a classification for the issue based on a trained classification model (e.g., trained inference model), (v) identify various devices associated with the person (e.g., all the devices registered to the person), (vi) attempt to communicate information regarding the issue to the person based on the channel (e.g., via the associated user devices 104), (vii) receiving acknowledgements from monitoring software hosted by the data processing system in response to providing the communication, and/or (viii) perform other tasks.

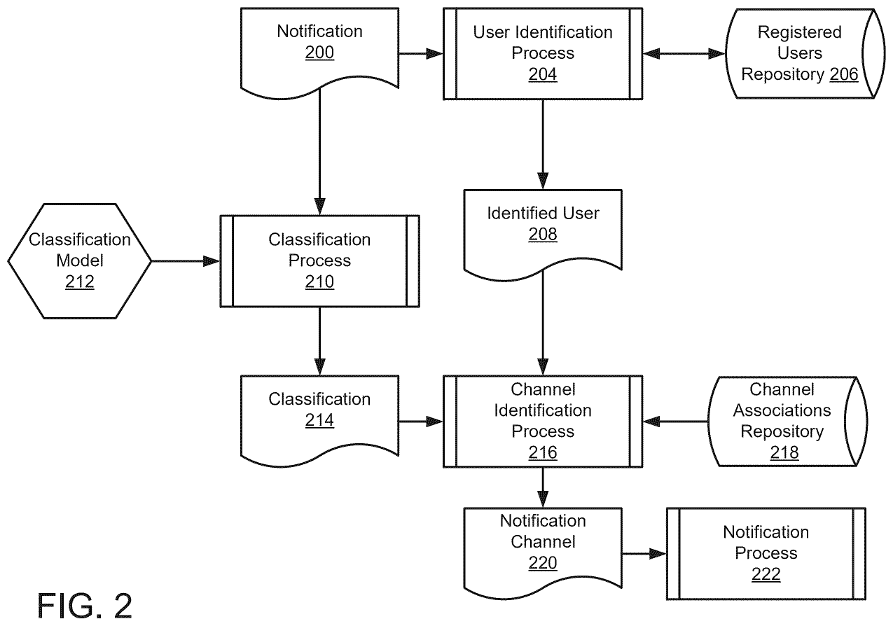

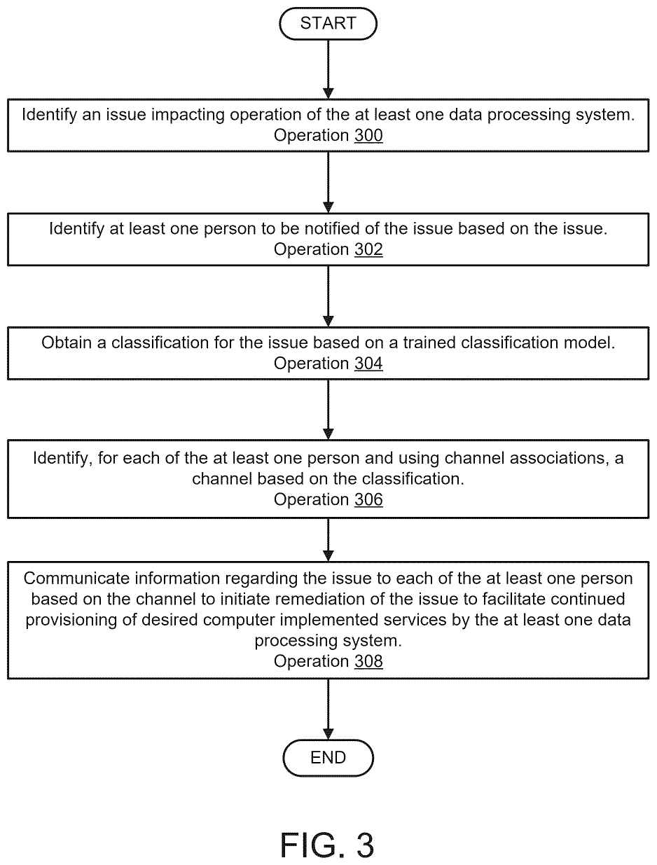

When providing their functionality, any of (and/or components thereof) deployment 100, management system 102, and/or user devices 104 may perform all, or a portion, of the actions and methods illustrated in FIGS. 2-3.

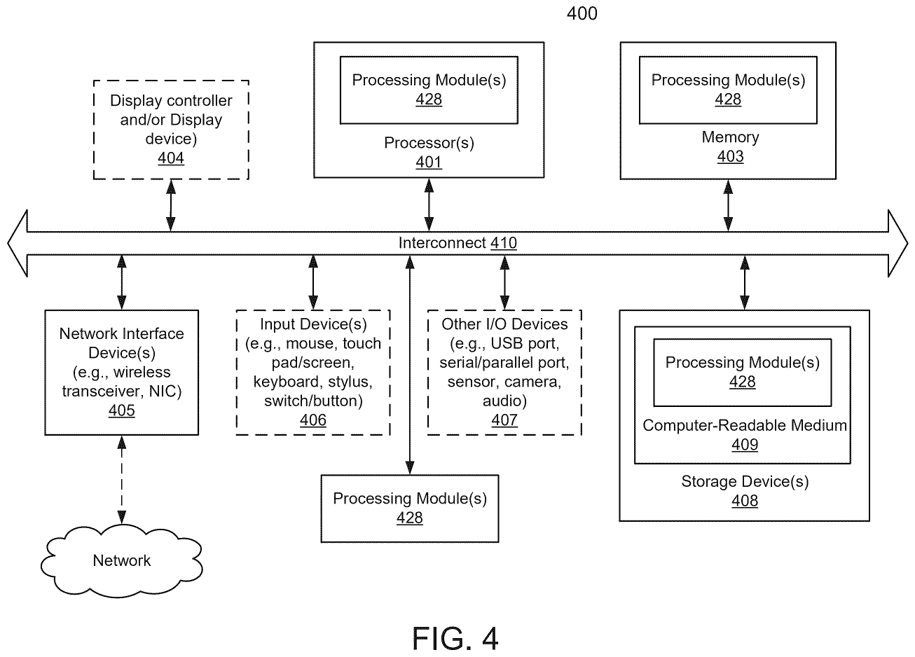

Any of (and/or components thereof) deployment 100, management system 102, and user devices 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIG. 2. In the diagram, flows of data and processing of data are illustrated using different sets of shapes. A first set of shapes (e.g., 200, 208, etc.) is used to represent data structures, a second set of shapes (e.g., 204, 210, etc.) is used to represent processes performed using and/or that generate data, a third set of shapes (e.g., 206, 218) is used to represent large scale data structures such as databases, and a fourth set of shapes (e.g., 212) is used to represent inference models.

Turning to FIG. 2, a data flow diagram in accordance with an embodiment is shown. The data flow diagram may illustrate data used in and data processing performed in attempting to communicate an issue (e.g., impacting operation of a data processing system) to a person (e.g., via a user device associated with the person).

To do so, notification 200 may be obtained from at least one data processing system (e.g., any of data processing systems 100A-100N) of a deployment (e.g., deployment 100). Notification 200 may include a message indicating an issue impacting operation of the data processing system.

Notification 200 may be used in performing user identification process 204. During user identification process 204, notification 200 may be subjected to any type of analysis process to identify a person (also referred herein as “a user”) tasked with managing an issue (e.g., identified by notification 200) impacting the desired computer implemented services being provided by a data processing system (e.g., data processing system 100A-100N). The user tasked with managing the issue may be identified from registered users repository 206.

Registered users repository 206 may include any type of repository (and/or other storage architecture) storing any quantity of users associated with managing various types of issues that may impact the desired computer implemented services provided by any of the data processing systems (e.g., data processing systems 100A-100N). For example, registered users repository 206 may include a database of individual users associated with managing different types of issues that may impact operation of a data processing system.

To identify the user associated with managing the issue, notification 200 may be subjected to any type of analysis process to identify the type of issue and/or any other information regarding the issue. For example, a large language model may be used to identify words and/or phrases included in notification 200 that are associated with a type of issue impacting data processing system 100A. For example, notification 200 may include the text “firmware update for storage system”. Based on the text, it may be identified that the word “storage” and the phrase “firmware update” may be used to identify the type of issue impacting the data processing system.

Once identified, the type of issue may be used to perform a lookup process as part of performing user identification process 204. During the lookup process, the type of issue may be used as a key to perform a lookup in a lookup table (e.g. including different types of issues associated with different users) to identify the person associated with managing the issue. Continuing the above example, the type of issue may include “storage” and an identifier for an issue relating to “storage” may be used a key to identify the user tasked with managing issues impacting a storage system (e.g., IT administrator, SME, etc.).

While described above with respect to identifying a single person or user tasked with managing the issue (e.g. identified by notification 200), it will be appreciated that any number of users associated with managing the issue may be identified.

As a result of performing user identification process 204, identified user 208 may be obtained. Identified user 208 may include: (i) identifier for the user associated with managing the issue, (ii) any information obtained from registered users repository 206 usable to identify the user, and/or (iii) other information.

In addition, notification 200 may be used in performing classification process 210. During classification process 210, the identified issue (e.g., specified by notification 200) may be analyzed using a trained classification model (e.g., classification model 212) to obtain a classification associated with the issue (e.g., classification 214).

Classification model 212 may be a trained machine learning model using training data (e.g., responses for remediating historic issues) obtained from any number of data processing systems of deployment 100. During classification process 210, generation of a response by classification model 212 may be initiated by feeding notification 200 into classification model 212 to obtain classification 214 as output from classification model 212.

Classification model 212 may generate classification 214 of the issue (e.g., specified by notification 200). Classification 214 may include, for example, a severity level of the issue, a priority level for the issue, and/or any other type of information usable to classify the issue. Different types of issues may be ascribed different levels of severity, priority, and/or any other classification defined by, for example, a subject matter expert (SME). The severity of the issue impacting the data processing system may include a level of impact (e.g., based on a numerical scale, predefined hierarchy of severity, and/or any other method for designating levels of severity).

For example, the level of severity may be based on a schema and/or rule set for assigning a defining characteristic such as “minor”, “major”, and “critical” to different types of issues. For example, an issue relating to “update availability” for a portion of software hosted by data processing system 100A may be ascribed a severity level of “minor” by a primary administrator of data processing system 100A based on minimal or low impact of the issue to facilitating continued provisioning of the desired computer implemented services by data processing system 100A. Conversely, an issue relating to “interrupted service” for a portion of software hosted by data processing system 100A may be ascribed a severity level of “critical” by the primary administrator based on a maximum or high impact of the issue interruption of the desired computer implemented services by data processing system 100A.

Classification 214 and/or identified user 208 may be used in performing channel identification process 216. During channel identification process 216, a channel for communicating the issue may be identified from a channel associations repository (e.g., channel associations repositories 218) associated with the user (e.g., identified user 208) and based on the classification of the issue (e.g., classification 214).

Channel associations repository 218 may be provided by a user, a management entity, a subject matter expert (SME), and/or any other entity participating in receiving communications regarding issues. Channel associations repository 218 may include any number of channel associations specifying associations between different channels and different classifications for issues for each person (e.g., each registered user to be notified of the issue).

The different channels may include independent communication paths between a management system (e.g., management system 102) and the person to be notified (e.g., identified user 208). For example, the different channels may include different forms of communication such as email correspondence, short message service (SMS), display notification, and/or any other type of communication. The independent communications paths may each be in different fault zones (e.g., meaning change to one channel will only impact one of the fault zones for the respective independent communication path). For example, two different communication channels may use different communication mediums (e.g., cellular networks, wireless communications, etc.) and as such, issues impacting one communication channel will not impact another communication channel.

For example, channel associations repository 218 may include any number of rule sets, thresholds, and/or other means of identifying a channel based on the classification of the issue (e.g., classification 214) for the respective identified user (e.g., identified user 208).

As a result of performing channel identification process 216, notification channel 220 may be obtained. Notification channel 220 may include: (i) identifier for the user associated with managing the issue and/or the user to be notified of the issue, (ii) a channel associated with the user to be notified, and/or (iii) any other information usable to notify the user of the issue impacting operation of the data processing system.

Notification channel 220 may be a template for identifying a mechanism of communicating the information of the issue based on an identified channel associated with the person. For example, notification channel 220 may indicate an email correspondence, text message, alert “pop-up” notification, and/or any other method of communication as the “channel” in which the issue may be communicated to the person (e.g., identified user 208).

Notification channel 220 may be used in notification process 222. During notification process 222, a notification indicating the issue may be generated and provided to the person (e.g., whom is to be notified of the issue) based on the notification channel 220. For example, if the notification channel indicates the form of communication to the user via text message, a look up process in a database (e.g., including phone numbers associated with different persons) using an identifier for the person to identify the phone number associated with the person.

As an additional example, if the notification channel indicates the form of communication to the user is to be via email correspondence, an identifier for the user may be used to identify an email address associated with the user.

As a result of performing notification process 222, information regarding the issue may be communicated to any user device that is to be notified of the issue via communication channel customized to the respective user device (based on, at least in part, on the classification of the issue). By doing so, the likelihood of the initiating remediation of the issue impacting the data processing system may be increased and thus, improving the likelihood of deployment 100 being able to provide the desired computer implemented services.

Thus, by implementing the data flows shown in FIG. 2, a system in accordance with embodiments disclosed herein may have an increased likelihood of providing communications regarding issues impacting data processing systems to one or more people tasked with managing issues impacting operation of a data processing system (e.g., administrator(s) of the data processing systems). By doing so, the likelihood of initiating remediation of the issues to facilitate continued provisioning of desired computer implemented services (e.g., by the data processing systems) may be increased. Consequently, a resource cost (e.g., computational resources, time resources, cognitive resources) of providing ineffective communications may be reduced.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2 may perform various methods for managing operation of at least one data processing system. FIG. 3 illustrate a method that may be performed by the components of the system of FIGS. 1-2. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of at least one data processing system in accordance with an embodiment is shown. The method may be performed, for example, by any of the components of the system of FIG. 1, and/or any other entity without departing from embodiments disclosed herein.

At operation 300, an issue impacting operation of the at least one data processing system may be identified. Identifying the issue may include: obtaining a communication from monitoring software hosted by the at least one data processing system, the communication indicating that the at least one data processing system is impacted by the issue. Obtaining the communication may include: (i) reading the communication from storage, (ii) receiving the communication from the monitoring software (e.g., via a message over a communication system), (iii) receiving the communication from another entity, and/or (iv) other methods.

At operation 302, at least one person to be notified of the issue may be identified based on the issue. The at least one person may be identified by: (i) performing a search of a registered user data repository using identified words and/or phrases as keywords for the search to identify entries in the registered user data repository associated with the issue, (ii) receiving identification of the at least one person from an external entity (e.g., based on user input and/or instructions), and/or (iii) performing other methods.

At operation 304, a classification for the issue may be obtained based on a trained classification model. Obtaining the classification for the issue may include: (i) generating an ingest data package (e.g., compiling the issue and other information into a data structure), (ii) initiating generation of the classification by the trained classification model (e.g., trained machine learning model and/or inference model), and/or (iii) performing other methods. Initiating generation of the classification by the trained classification model may include: (i) providing the ingest data package to an entity responsible for hosting and operating the trained classification model, (ii) feeding the ingest data package into the trained classification model and obtaining the classification as output from the trained classification model, and/or (iii) other methods.

At operation 306, a channel for each of the at least one person may be identified based on the classification. Identifying the channel for each of the at least one person may include: (i) identifying channel associations for the at least one person, (ii) performing a lookup process in a database (e.g., including identifiers for the at least one person and classifications for the issue) using the classification as a key for a lookup table included in the database, and/or (iii) other methods.

At operation 308, information regarding the issue may be communicated to each of the at least one person based on the channel to initiate remediation of the issue to facilitate continue provisioning of desired computer implemented services by the at least one data processing system. Communicating the information regarding the issue may include: (i) generating a notification (e.g., compiling the issue, classification of the issue, and any other information into a data structure) for each of the at least one person, (ii) providing the notification to the at least one person using the identified channel (e.g., via a message over a communication system, via a graphical user interface (GUI) on a device), and/or (iii) other methods.

Generating the notification may include: (i) obtaining device information for the at least one person based on the identified channel, (ii) generating a message for each of the at least one person indicating the issue impacting the at least one data processing system, and/or (iii) other methods.

Obtaining the device information may include: (i) performing a lookup process in a database (e.g., including identifiers for devices registered to persons and characteristics for the devices) using the first characteristics as a key for a lookup table included in the database, (ii) obtaining, as a result of the lookup process, a list of devices for the at least one person and corresponding contact information for the devices associated with the at least one person, and/or (iii) other methods.

The method may further include: after communicating the issue: (i) monitoring the operation of the at least one data processing system until the issue is resolved by action of the at least one person induced by the communicating of the issue, (ii) making the issue as resolved, and/or (iii) other methods.

The method may end following operation 308.

Thus, using the methods illustrated in FIG. 3, embodiments disclosed herein may provide systems and methods usable to managing operation of at least one data processing system by communicating an issue impacting operation the at least one data processing to at least one person using an identified channel. The channel for the at least one person may be identified based on a classification of the issue and may identify an independent communication path between a management system and the at least one person. By communicating the issue using the identified channel, the at least one person may initiate remediation of the issue impacting the at least one data processing system. By doing so, the likelihood of remediating the issue may be increased while conserving limited resources and thereby facilitating continued provisioning of desired computer implemented services by the at least one data processing system as part of a deployment.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense. Please amend the claims as follows:

1. A method for managing operation of at least one data processing system, the method comprising:
executing a software program to monitor a storage device of the at least one data processing system;
identifying, using the software program, an issue of the storage device storing data;
identifying at least one person to be notified of the issue based on the issue;
obtaining a classification for the issue based on a trained classification model;
identifying, for each of the at least one person and using channel associations, a channel based on the classification, the channel being selected from a plurality of different channels respectively associated with a plurality of different wireless communication mediums; and
communicating information regarding the issue to each of the at least one person based on the channel; and
updating firmware of the storage device to remediate the issue.

2. The method of claim 1, wherein the channel associations specify, for a person of the at least one person, associations between the plurality of different channels and a plurality of different classifications.

3. The method of claim 2, wherein each of the plurality of different channels comprise independent communication paths between a management system and the person.

4. The method of claim 3, wherein the independent communication paths are each in different fault zones.

5. The method of claim 1, wherein the trained classification model classifies a severity level of the issue.

6. The method of claim 1, wherein the trained classification model classifies a priority level for the issue.

7. The method of claim 1, wherein the trained classification model is a trained machine learning model based on training data obtained from a plurality of data processing systems and corresponding responses for remediating historic issues impacting the plurality of data processing systems.

8. The method of claim 1, wherein the at least one data processing system is a member of a deployment tasked with providing computer implemented services to users, and the issue reduces a likelihood of the deployment being able to provide computer implemented services.

9. The method of claim 8, wherein identifying the issue comprises:
obtaining a communication indicating that the at least one data processing system is impacted by the issue.

10. The method of claim 9, further comprising:
after communicating the issue:
monitoring the operation of the at least one data processing system until the issue is resolved by action of the at least one person induced by the communicating of the issue; and
making the issue as resolved.

11. A non-transitory machine-readable medium having instructions stored therein, which when executed by a processor, cause the processor to perform operations comprising:
executing a software program to monitor a storage device of at least one data processing system;
identifying, using the software program, an issue of the storage device storing data;
identifying at least one person to be notified of the issue based on the issue;
obtaining a classification for the issue based on a trained classification model;
identifying, for each of the at least one person and using channel associations, a channel based on the classification, the channel being selected from a plurality of different channels respectively associated with a plurality of different wireless communication mediums;
communicating information regarding the issue to each of the at least one person based on the channel; and
updating firmware of the storage device to remediate the issue.

12. The non-transitory machine-readable medium of claim 11, wherein the channel associations specify, for a person of the at least one person, associations between the plurality of different channels and a plurality of different classifications.

13. The non-transitory machine-readable medium of claim 12, wherein each of the plurality of different channels comprise independent communication paths between a management system and the person.

14. The non-transitory machine-readable medium of claim 13, wherein the independent communication paths are each in different fault zones.

15. The non-transitory machine-readable medium of claim 11, wherein the trained classification model is a trained machine learning model based on training data obtained from a plurality of data processing systems and corresponding responses for remediating historic issues impacting the plurality of data processing systems.

16. A data processing system, comprising:
a processor; and
a memory coupled to the processor to store instructions, which when executed by the processor, cause the processor to perform operations comprising:
executing a software program to monitor a storage device of at least one data processing system;
identifying, using the software program, an issue of the storage device storing data;
identifying at least one person to be notified of the issue based on the issue;
obtaining a classification for the issue based on a trained classification model;
identifying, for each of the at least one person and using channel associations, a channel based on the classification, the channel being selected from a plurality of different channels respectively associated with a plurality of different wireless communication mediums;
communicating information regarding the issue to each of the at least one person based on the channel; and
updating firmware of the storage device to remediate the issue.

17. The data processing system of claim 16, wherein the channel associations specify, for a person of the at least one person, associations between the plurality of different channels and a plurality of different classifications.

18. The data processing system of claim 17, wherein each of the plurality of different channels comprise independent communication paths between a management system and the person.

19. The data processing system of claim 18, wherein the independent communication paths are each in different fault zones.

20. The data processing system of claim 16, wherein the trained classification model is a trained machine learning model based on training data obtained from a plurality of data processing systems and corresponding responses for remediating historic issues impacting the plurality of data processing systems.
